(19) United States
(12) Patent Application Publication
(10) Pub. No.: US 2011/0251913 A1
(43) Pub. Date: Oct. 13, 2011

(54) Electronic commerce telecommunication telephone number bank key computer data bank

(76) Inventor: Keith Anthony Washington, Oakland, CA (US)

(21) Appl. No.: 12/798,573

(22) Filed: Apr. 7, 2010

(51) Int. Cl. G06Q 40/00; G06Q 30/00

(52) U.S. Cl. 705/26.1

(57) ABSTRACT

A computer based method for preventing electronic bank robbery and account hijacking. The method provides the online account holder to access electronic bank accounts, storefronts, and electronic mail, etc. by using their telephone number as an electronic commerce account access key. For providing telecommunication caller identification, account access verification. The institution provides a 1-800 number with caller identification, electronic numerical telephone number key tumbler account holder verification. The telephone number key tumbler can also prevent electronic auction fraud. The key tumbler can monitor the merchant's account activities, and prevent merchant fraud from repeat offenders.

### BACKGROUND OF THE INVENTION

This invention relates to electronic bank robbery, account hijacking, and electronic auction fraud.

### DESCRIPTION OF PRIOR ART

The increasing number of people migrating to the Internet to bank, and to pay bills, has helped spur the growth of account hijacking, and bank robbery, a subset identity theft that involves unauthorized access to checking accounts. Gartner Inc, a research and advisory firm, calls it the fastest growing type of financial consumer fraud in the United States robbing nearly two million people of an estimated $2.4 billion in a recent 12-month period.

The problem of account hijacking may seem relatively small when compared to overall identity theft, which victimized 10 million Americans and steals $53 billion from businesses and consumers annually. But the speed at which account hijacking is growing could threaten to undermine whatever faith consumers have in handling banking and other financial transactions online. Much of account hijacking is accomplished through phishing and hacking. Phishing emails are fraudulent emails that purport to be from your bank and require you to click on a link and then enter personal information that enables the skimmer to access your account.

But thanks to fraud tactics such as Trojan Horses and keystroke logging some phishing scars don't require you to click on a link, just opening the email can trigger a virus that directs your computer to a fake page when you type the bank's internet address. You then type in your credentials and the bad guy steals them.

Some days, banks are targeted dozens of times, which not only leads to identity theft, but also jam-paced customer service telephone lines. Clearly the issues are far more significant than anyone expected they would be. Phishing and spoofing (setting up look-alike bank web sites) are really getting to people, it is an epidemic, it's a very big problem. But phishing isn't the only way criminals gain access to online bank accounts, according to industry experts. Computer criminals are becoming increasingly proficient at writing Trojan Horse programs and keyloggers that steal passwords and account information. Such secret malicious programs, which experts say are more widespread than many realize, could be the cause of up to half the account takeovers.

The Gartner survey found that more than 4 million consumers reported suffering checking account takeovers at any time during recent years, with half that number saying it had happened in the most recent 12-months span indicating a sharp increase in the activity. While consumers who responded to the survey didn't know how the money was moved out of their checking accounts. Criminals are using creative ways to transfer money out of hijacked accounts. Another method, takes advantage of the images of canceled checks made available to online bankers. Impostors use them to create authentic looking counterfeit checks; they have an added air of legitimacy, since the check numbers are appropriately in series. Online banking, including online bill paying, has spiked in popularity in recent years, particularly as more financial institutions offer the service for free. 45 percent of the 141 million U.S. adults who use the Internet pay bills online. Consumers like the convenience and banks like the operating savings. The solution to the problems of electronic bank robbery comes with a very simple solution, operate the e-commerce bank with the same manner of security as the brick and mortar bank.

The Federal Trade Commission and 29 states have launched a campaign to crack down on Internet auction fraud. “Operation Bidder Beware” has resulted in 57 criminal and civil law enforcement actions in a sweep involving the coordination of the FTC, attorney general of the participating states and local police agencies, according to the FTC. Online auction fraud is the No. 1 type of Internet related complaint tracked by the FTC in terms of volume, according to the agency. The FTC received about 51,000 complaints regarding online-auction scams, representing about $37 million in losses. That number likely represents just a fraction of the actual number of rip-offs that occurred, officials said.

Although the vast majority of complaints involve the collection of payments for goods that never materialize, the authorities are seeing a few new twists. One involves identity theft by sellers in order to cover their tracks and throw investigation off track. In some cases, scam artist have taken over the accounts of other online sellers. Another problem involves fraudulent escrow services that collect either payments and merchandise or both, ripping off both buyers and sellers. Many states are short on the resources needed to pursue offenders and that the virtual nature of the Internet can throw a wrench into the jurisdiction of these cases. For that reason, prevention and consumer awareness are major aspects of the operation. The solution to online auction houses and other seller accounts, is to verify each merchant, create some form of a paper trail, just like a brick and mortar storefront, criminals do not like paper trails.

### OBJECTS AND ADVANTAGES

Accordingly, several objects and advantages of the present invention are:
(a) A computer based method, providing telecommunication account access keys, which can prevent electronic bank robbery and account hijacking.
(b) A computer based method, providing telecommunication account access keys, which cannot be stolen.
(c) A computer based method, providing telecommunication account access keys, which makes banking online safe and secure.
(d) A computer based method, providing telecommunication account access keys, which will encourage people to bank online.
(e) A computer based method, providing telecommunication account access keys, which are 100% secure without the use or development of any major technology, which can be used to secure any electronic institution on the Internet.
(f) A computer based method, providing electronic commerce telephone number account access keys, and providing electronic numerical telephone number key tumblers, which can prevent any account hijacking method imaginable.

Further objects and advantages are to provide an account registration method which can prevent a perpetrator from repeatedly posting fraud auctions. Caller ID account access will block the perpetrator after the first fraud auction is reported, forcing the perpetrator to abandon the fraud operation.

### BRIEF SUMMARY OF THE INVENTION

An electronic commerce telephone number account access key system and method, which is used whenever an account holder wants access to an electronic commerce institution. The electronic institution provides access to the account by providing a 1-800 number with caller ID system verification, electronic numerical telephone number key tumbler account access. The account holder calls from the phone that is registered to the electronic numerical telephone number key tumbler, to gain access into the electronic institution.

### DETAILED DESCRIPTION OF THE INVENTION

The Electronic Commerce Telephone Number Bank Key Computer Data bank will provide the usual manner of procedure for registration with one key difference. At the time of registration, the user, John Doe, will enter his full telephone number, and the last 5 digits of his telephone number, to be used as a telephone number account access key, and electronic numerical telephone number key tumbler. After the user is registered into the electronic institution, and they log off, the only way to regain access to their account is to use the telephone number account access key. Only the institution can issue a new telephone number account access key, and telephone number key tumbler, after the first registration.

The institution will provide a 1-800 number to prevent caller ID spoofing. The electronic institution will have computer caller ID software. Which will match the caller's registered telephone number account access key to the registered electronic numerical telephone number key tumblers. This is a caller identification, telephone number key, match and verify telephone number key tumbler account access system.

Electronic telephone number key tumbler, (1-2345).
Telephone number account access key 000-001-2345.

John Doe calls the institution with his telephone phone number account access key, 000-001-2345, the caller ID software receives John Doe's access key call: (John Doe 000-001-2345), and matches John Doe's telephone number key to the key tumbler;

(John Doe 000-001-2345) John Doe is given immediate account access John Doe 1-2345.
Caller ID software is equipped to match an identified phone number with numbers stored in the computers database.
Providing software in the present invention will process all of this information, including the key tumbler. The computer system will send a signal to the providing web page, providing the customer with immediate account access after dialing the 1-800 number.

### Operation

If a person with a bank account with a brick and mortar bank wants to start electronic banking online, the bank's web site will operate with the same manner of security as the brick and mortar bank. The account holder will be provided with an electronic commerce bank key, before given access to the account. After the account holder is registered with the electronic bank, and has issued the telephone number account access key, and key tumbler, the online banker will simply enter their username and password. The account holder will then call the bank with a provided 1-800 number. The bank will verify the account holder by matching the caller's registered telephone number account access key, to the registered electronic numerical telephone number key tumbler. If the telephone number key, the customer is using does not match the registered telephone number key tumbler, the electronic key tumbler will not allow the customer into the electronic bank. The telephone number key, and telephone number key tumbler functions with the same principle as a normal key and lock functions.

For a person to enter into a brick and mortar institution, the right key is needed in order to turn the key tumblers in the lock. The person cannot travel to a different location and use the same key, the key will only work in the lock it was made for. This method is the same for the telephone number bank key. The Electronic Commerce Telecommunication Telephone Number Bank Key Computer Data Bank, employs telephone numbers, as electronic numerical data, match and verify key tumblers. When a person is banking at home, the bank is in the person's home, and the key to gain access is the registered telephone number account access key. If a person wants to enter into an electronic institution, the caller's telephone number account access key, must match the providing electronic numerical telephone number key tumblers, to gain access.

If the account holder wants to change their account access key, and key tumbler, the account holder will go to a brick and mortar bank, and the bank will issue a new telephone number access key, and key tumbler. If it is not possible for the account holder to go to the bank, the bank can provide the option of downloading a form to have the key, and key tumbler changed with a notarized document. If the new telephone number is in the account holder's name, the account holder could contact the bank by phone. The bank will use a caller ID system to verify the call, and number, and issue the new telephone number key and key tumbler with that number.

The electronic commerce telecommunication telephone number account access key system, can also be used for online auctions, electronic storefronts, and electronic mail, etc. With this method of registration, the online auction house can prevent fraud auctions by repeat offenders. By using telephone registrations, the online auction house will know which telephone number access key is posting fraud auction, and block that telephone number from using the system. The electronic telephone number key tumbler would identify, and verify all selling transactions. The key tumbler would be used to monitor the merchants selling activities. The auction house can set up the system to prevent phone booth registrations, shutting down the perpetrators options. The perpetrator would need to find a new phone landline to register for every other fraud auction, forcing the perpetrator to abandon the fraud operation. Telephone registration would prevent fraud, and would make it easy to track perpetrators down to be arrested, and charged with fraud.

At the time of registration, the account holder will be provided with a 1-800 number with caller ID verification, and a pin number. The pin number will be used to change the registered electronic numerical telephone number key tumbler. If the member is contacting the auction house because the telephone number and account access key is no longer in service, and they want to register a new key, and key tumbler; the auction house would verify the member on the phone. The auction house would request the pin number given at registration, and ask any other questions to verify the member. The auction house could also provide a registration method for wireless telecommunication devices, providing the same control as a landline, with better account holder verification. Providing cell phone registrations, truly verifies the seller, and will definitely prevent fraud on the Internet. Providing the mobile merchant the ability to conduct business transactions on the go, with an account holder identification security system. The user would fill out all cell phone billing information on the web site, and fax a copy of the cell phone billing statement. The auction house would then verify the owner of the cell phone, online, with a cell phone owner verification service. The auction house would then activate the account.

Members of the auction house would not need to constantly call the 1-800 number every time they want to access their account. Buyers who do not plan on becoming sellers would not need to phone in, but would still register their phone number and create the telephone number account access key tumbler. If the buyer builds a large positive feedback rating, and a perpetrator hijacks the account to post goods for sale, the telephone number account access key and key tumbler, would be needed to change the account to a sellers account. The telephone number account access key and telephone number key tumbler, would be used to verify the account holder. This method of account access is so secure, that the account holder could be permitted to call in only once a month, and whenever changes are made to the account, or, they sign out.

1. A computer based method for preventing electronic commerce bank robbery and account hijacking, by manually entering telephone number digits into an electronic commerce telecommunication telephone number bank key computer data bank, and issuing a telephone number account access key, and creating an electronic numerical telephone number key tumbler, for accessing electronic bank accounts, and electronic storefronts, the electronic commerce telecommunication telephone number bank key computer data bank, comprising:
(a) manually entering telephone number digits into said electronic commerce telecommunication telephone number bank key computer data bank, to issue said telephone number account access key, and create said electronic numerical telephone number key tumbler,
(b) providing telecommunication caller identification electronic numerical telephone number key tumbler account access, whenever the online account holder wants to re-access their account,
(c) the account holder can only gain access to their account from the providing account access phone that is registered to providing said electronic numerical telephone number key tumbler,
(d) said telephone number account access key will be processed for electronic institution account access, by matching said telephone number account access key, to providing said electronic numeric telephone number match and verify key tumbler account access system,
(e) only the institution can change providing said electronic numerical telephone number key tumbler, and said telephone number account access key after they are registered, a means for providing telecommunication telephone number key caller identification, providing telephone number key account access verification,
whereby said electronic commerce telecommunication telephone number bank key computer data bank provides telephone number digits to be entered for providing said electronic numerical telephone number key tumblers, and said telephone number account access keys, which prevents electronic bank robbery, and electronic commerce account hijacking, by providing telecommunication bank key identification, telecommunication bank key account access verification.

2. A computer based method for preventing electronic commerce merchant fraud, with wireless telecommunication devices, for electronic commerce transactions, employing telephone number digits to identify and verify the wireless electronic commerce user, providing the user with a wireless secure account access key, monitoring merchant account activities, for mobile business transactions, by entering telephone number digits into an electronic commerce telecommunication telephone number bank key computer data bank, and issuing a telephone number account access key, and creating an electronic numerical telephone number key tumbler, providing caller telecommunication account identification and merchant verification, the electronic commerce telecommunication telephone number bank key computer data bank, comprising:
(a) registering the wireless telecommunication device by manually entering the telephone number digits into said electronic commerce telecommunication telephone number bank key computer data bank, and issuing said telephone number account access key, and creating providing said electronic numerical telephone number key tumbler,
(b) the wireless device owner registers the device billing information, and provides a copy of the wireless device statement,
(c) the wireless device owner is provided with an active electronic commerce sellers account,
(d) the electronic institution provides the wireless telecommunication merchant secure account access, providing telecommunication telephone number key identification, providing electronic telephone number key tumbler wireless merchant verification,
(e) the electronic institution monitors the electronic merchants account activities, providing processing said electronic numerical telephone number key tumbler, a means for providing wireless telecommunication mobile internet telephone number account key identification, providing telephone number key account holder verification,
whereby said electronic commerce telecommunication telephone number bank key computer data bank provides telephone number digits of wireless telecommunication devices to be entered, for providing secure mobile account access, for mobile electronic merchants, by providing said telephone number account access key identification, and providing said electronic telephone number key tumbler verification, a computer based method for registering and processing wireless telecommunication, which provides the electronic institution with detailed verified account registration information, and account access verification, to prevent electronic merchant fraud from repeat offenders.
